(19) United States
(12) Patent Application Publication
(10) Pub. No.: US 2016/0311220 A1
(43) Pub. Date: Oct. 27, 2016

(54) PRINTING APPARATUS, PRINT HEAD, AND PRINTING METHOD

(71) Applicant: MIMAKI ENGINEERING CO., LTD., Nagano (JP)

(72) Inventor: MASARU OHNISHI, NAGANO (JP)

(73) Assignee: MIMAKI ENGINEERING CO., LTD., NAGANO (JP)

(21) Appl. No.: 15/104,980

(22) PCT Filed: Dec. 19, 2014
(86) PCT No.: PCT/JP2014/083795

§ 371 Date: Jun. 16, 2016

(30) Foreign Application Priority Data
Dec. 20, 2013 (JP) 2013-263697

(51) Int. Cl. B41J 2/145

(52) U.S. Cl. CPC B41J 2/145

(57) ABSTRACT

A printing apparatus which performs printing in an inkjet mode is provided and includes a head unit including nozzle rows in which a plurality of nozzles configured to eject ink drops is aligned, and a main scan driver drives the head unit to perform main scan operations of ejecting ink drops while moving in a predetermined main scan direction, wherein the head unit includes three or more nozzle rows in which the plurality of nozzles aligned in the main scan direction is arranged side by side in a sub scan direction perpendicular to the main scan direction, and the three or more nozzle rows are installed side by side in the main scan direction, and each of the nozzle rows is installed such that the positions of its ends in the sub scan direction are deviated from those of each adjacent nozzle row in the main scan direction.

### TECHNICAL FIELD

The disclosure relates to a printing apparatus, a print head, and a printing method.

### BACKGROUND ART

In the related art, inkjet printers for performing printing in an inkjet scheme are widely used (see Patent Literature 1 for instance). In Patent Literature 1, with respect to a case of performing printing with a so-called line head, there is disclosed a configuration making it possible to obtain an excellent print result without requiring high assembly accuracy of inkjet heads. Also, in the related art, as a method of performing printing by an inkjet printer, printing in a serial mode for performing main scan operations (scanning operations) in a predetermined main scan direction with an inkjet head is widely used.

### CITATION LIST

### Patent Literature

Patent Literature: JP-A-2005-193654

### SUMMARY

### Technical Problem

In an inkjet printer, ink drops ejected from nozzles fly in the air, and reach a medium. For this reason, for example, if the flying ink drops are influenced by the surrounding air current, deviations in the landing positions of ink drops may occur.

Also, especially, in a case of performing printing in a serial mode, since an inkjet head ejects ink drops while moving, the inkjet head ejects ink drops in a state where air is relatively flowing with respect to the inkjet head. Further, in an inkjet head which is used in the serial mode, generally, there is formed a nozzle row in which a number of nozzles are aligned in line in a sub scan direction perpendicular to a main scan direction. Also, in a case of ejecting ink drops from the nozzles of the inkjet head, variation in the air current according to the ejecting operation also occurs. Therefore, while ink drops which are ejected from each individual nozzle are flying, they are influenced by the air current which is generated by ejection of ink drops from the surrounding nozzles.

Also, in the nozzle row, in case of a nozzle of the central portion, on both sides of the corresponding nozzle in the sub scan direction, there are other nozzles. Meanwhile, in case of a nozzle of each end of the nozzle row, only on one side of the corresponding nozzle in the sub scan direction, there are other nozzles. Therefore, in case of a nozzle of each end of the nozzle row, between one side and the other side in the sub scan direction, it is easy for a difference in the influence of the air current to occur. Also, as a result, in ink drops ejected from the nozzles of the ends of the nozzle row, it becomes easy for flight curve or the like to occur.

Also, in the case of performing printing in the serial mode, generally, main scan operations are performed alternately with sub scan operations of performing, for example, medium conveyance. Therefore, the number of places where printing is performed by the nozzles of the ends of the nozzle row also increases according to the number of main scan operations. Also, as a result, in the inkjet printer which performs printing in the serial mode, it may become easy for ink drops which are ejected from the nozzles of the ends of the nozzle row to be influenced by deviations in the landing positions and so on. Also, due to such influence, for example, in a case of performing printing at high resolution, the quality of printing may decrease. Specifically, for example, it is conceivable that, due to deviations in the landing positions of ink drops which are ejected from the nozzles of the ends, banding or the like occurs, and thus the quality of printing decreases.

Here, with respect to this problem, for example, it can be considered to set some nozzles in the vicinities of the ends of the nozzle rows, as dummy nozzles which do not eject ink drops, and repeatedly perform printing on an area on which printing should be performed by the nozzles in the vicinities of the ends of the nozzle rows, a plurality of times, by a plurality of main scan operations or a plurality of inkjet heads. According to this configuration, for example, even in a case where deviations occur in the landing positions of ink drops which are ejected from the nozzles of the ends, it is possible to uniformize the influences of the deviations. Also, as a result, it is possible to suppress a decrease in the quality of printing.

However, in case of this configuration, since some nozzles of the nozzle rows are set as dummy nozzles, the number of nozzles usable in each main scan operation decreases. Also, as a result, the sub scan direction width of an area on which printing is performed by one main scan operation narrows. Further, as a result, in this case, according to the width of a range in which dummy nozzles are set, printing speed decreases.

For this reason, in the related art, as a configuration which suppresses a decrease in the quality of printing, a more appropriate configuration has been required. It is therefore an object of the disclosure to provide a printing apparatus, a print head, and a printing method capable of solving the above described problems.

### Solutions to Problem

In order to solve the above described problems, the disclosure has the following configurations.

(First Configuration)

A printing apparatus which performs printing in an inkjet mode includes a head unit configured to include nozzle rows in which a plurality of nozzles configured to eject ink drops is aligned, and a main scan driver configured to drive the head unit to perform main scan operations of ejecting ink drops while moving in a predetermined main scan direction, wherein the head unit includes three or more nozzle rows in which the plurality of nozzles having positions aligned in the main scan direction is arranged side by side in a sub scan direction perpendicular to the main scan direction, and the three or more nozzle rows are installed side by side in the main scan direction, and each of the nozzle rows is installed such that the positions of its ends in the sub scan direction are deviated from those of each adjacent nozzle row in the main scan direction. The number of nozzle rows is preferably 4 or more. Also, the positions of the ends of the individual nozzle rows are deviated from each other, for example, in the sub scan direction, by an integral multiple of the resolution pitch of a final printed material. In this case, the final printed material means, for example, a printed material on which the printing apparatus has completed printing.

With respect to the nozzle rows, the positions of the ends in the sub scan direction are, for example, the positions of ends on one side predetermined in the sub scan direction. The three or more nozzle rows are, for example, nozzle rows for ejecting ink drops of the same color. Also, the head unit includes, for example, an inkjet head having three or more nozzle rows. The head unit may be, for example, a combined head which is composed of a plurality of inkjet heads. In this case, each inkjet head includes, for example, one or more nozzle rows.

In this configuration, for example, in each main scan operation, ink drops are ejected from the nozzles of the plurality of nozzle rows onto an area of a medium over which the head unit passes. Therefore, according to this configuration, for example, it is possible to appropriately uniformize the ejection characteristics of the plurality of nozzle rows. Also, in this configuration, the positions of the individual nozzle rows are deviated from each other in the sub scan direction. Therefore, for example, the position of a nozzle of an end of one nozzle row is close not to a nozzle of an end of each adjacent nozzle row, but to a nozzle other than the nozzle of the end. Also, as a result, the landing positions of ink drops which are ejected by the nozzles of the ends of the plurality of nozzle rows are deviated from each other in the sub scan direction.

Therefore, in case of this configuration, it is possible to appropriately disperse the landing positions of ink drops corresponding to the nozzles of the ends of the individual nozzle rows, in the sub scan direction. Also, as a result, for example, even in a case where deviations occur in the landing positions of ink drops which are ejected from the nozzles of the ends, it is possible to appropriately uniformize the influences of the deviations. Therefore, according to this configuration, for example, even in a case where deviations occur in the landing positions of ink drops which are ejected from the nozzles of the ends of the nozzle rows, it is possible to appropriately prevent banding and the like from occurring. Also, as a result, it is possible to appropriately suppress a decrease in the quality of printing.

Also, in this configuration, for example, it is possible to appropriately disperse the influences of the nozzles of the ends of the nozzle rows, without setting some nozzles of the nozzle rows as dummy nozzles. Therefore, according to this configuration, for example, it is also possible to more efficiently use the nozzles of the nozzle rows to perform printing.

Also, with respect to the number of nozzle rows, it can be said that, in terms of improving the quality of printing, it is preferable to increase the number of nozzle rows. However, in this case, a problem that the configuration of the head unit becomes bigger occurs. For this reason, it is conceivable that it is preferable that the number of nozzle rows is about 3 to 5 (for example, 4).

Also, with respect to a configuration using a plurality of nozzle rows arranged side by side in the sub scan direction, as a configuration superficially similar to the above described configuration, for example, a configuration in which, in order to perform printing at resolution higher than the intervals (pitches) at which nozzles are aligned in line in each nozzle row, two nozzle rows are used and the positions of the nozzles of the individual nozzle rows are deviated from each other in the sub scan direction by half of a pitch can be conceivable. However, in this configuration, for example, since the deviation pattern of the positions of the ends of the nozzle rows is small, it is conceivable that, in a case where deviations occur in the landing positions of ink drops which are ejected from the nozzle of the end of any one nozzle row, it is difficult to sufficiently uniformize the influences of the deviations. In contrast with this, according to the first configuration, for example, it is possible to more appropriately uniformize the influences of the deviations.

(Second Configuration)

Even in a case where three consecutive nozzle rows which are arranged side by side in the main scan direction are selected from the three or more nozzle rows, when the selected three nozzle rows are referred to as a first row, a second row, and a third row in the order along the main scan direction, with respect to the positions of the ends of the individual nozzle rows in the sub scan direction, the position deviation between the first row and the second row is larger than the position deviation between the first row and the third row.

In this configuration, with respect to the consecutive nozzle rows arranged side by side in the main scan direction, that is, the first row, the second row, and the third row, the position deviation in the sub scan direction between the first row and the second row is larger than the position deviation between the first row and the third row. This deviation pattern is, more specifically, deviations of a zigzag shape. The deviations of the zigzag shape may be, for example, deviations of a jagged shape, a sinusoidal shape, or a triangular wave shape. According to this configuration, as compared to some cases such as a case where the ends of the individual nozzle rows are deviated from each other so as to be put on a straight line, it is possible to disperse the landing positions of ink drops corresponding to the nozzles of the ends of the nozzle rows such that it is more difficult to visually recognize the landing positions. Also, as a result, it is possible to more appropriately uniformize the influences of the deviations. Also, as a result, for example, even in a case where deviations occur in the landing positions of ink drops which are ejected from the nozzles of the ends of the nozzle rows, it is possible to more appropriately suppress a decrease in the quality of printing.

(Third Configuration)

The individual nozzle rows are the same in the number of nozzles which are aligned in the sub scan direction therein, and the three or more nozzle rows are installed side by side in the main scan direction such that the positions of the ends of the individual nozzle rows are deviated from each other in the sub scan direction.

According to this configuration, for example, it is possible to appropriately set the positions of the nozzles of the ends of the individual nozzle rows such that they are deviated from each other. Also, as a result, for example, even in a case where deviations occur in the landing positions of ink drops which are ejected from the nozzles of the ends of the nozzle rows, it is possible to more appropriately suppress a decrease in the quality of printing.

(Fourth Configuration)

The head unit includes four or more nozzle rows which are arranged side by side in the main scan direction. According to this configuration, for example, even in a case where deviations occur in the landing positions of ink drops which are ejected from the nozzles of the ends, it is possible to more appropriately uniformize the influences of the deviations. Also, as a result, it is possible to more appropriately suppress a decrease in the quality of printing.

(Fifth Configuration)

With respect to adjacent nozzle rows in the main scan direction, the magnitudes of deviations of the positions of the ends in the sub scan direction are larger than a distance which is obtained from a spatial frequency corresponding to a peak value of a visual transfer function. According to this configuration, for example, by arranging the nozzles of the ends of adjacent nozzle rows such that their positions are sufficiently deviated from each other, it is possible to more appropriately prevent the influences of the nozzles of the ends of adjacent nozzle rows from being perceived as overlapping each other. Also, as a result, for example, it is possible to more appropriately suppress a decrease in the quality of printing.

(Sixth Configuration)

In the three or more nozzle rows, all of the deviations between the positions of the ends of each nozzle row in the sub scan direction, and the positions of the ends of the other nozzle rows in the sub scan direction are larger than the distance which is obtained from the spatial frequency corresponding to the peak value of the visual transfer function. According to this configuration, for example, by arranging the nozzles of the ends of the individual nozzle rows such that their positions are sufficiently deviated from each other, it is possible to appropriately prevent the influences of the nozzles of the ends of the nozzle rows from being perceived as overlapping each other. Also, as a result, for example, it is possible to more appropriately suppress a decrease in the quality of printing.

(Seventh Configuration)

The intervals in the main scan direction between ink dots which are formed on a medium by the individual nozzle rows during the main scan operations are larger than a distance which is obtained from a spatial frequency corresponding to a peak value of a visual transfer function. According to this configuration, for example, by setting sufficiently large intervals between dots to be formed on a medium by one nozzle row, it is possible to appropriately prevent the states of dots which are formed side by side in the main scan direction by the nozzles of the ends, from being perceived as overlapping each other. Also, as a result, for example, it is possible to more appropriately suppress a decrease in the quality of printing.

(Eighth Configuration)

During a printing operation of performing printing on a medium, printing is performed using all nozzles of the individual nozzle rows. According to this configuration, for example, with respect to the sub scan direction width of an area on which printing is performed by one main scan operation, it is possible to set a wider width, without reducing the width, unlike in a case of setting dummy nozzles. Also, as a result, for example, it is possible to more appropriately perform high-quality printing while preventing a decrease in printing speed.

(Ninth Configuration)

In the individual nozzle rows, the plurality of nozzles is aligned in line at predetermined nozzle intervals in the sub scan direction, and in each nozzle row, the positions of each nozzle in the sub scan direction are deviated from the positions of all nozzles of the other nozzle rows in the sub scan direction, and with respect to resolution in the sub scan direction, the printing apparatus performs printing at resolution higher than resolution corresponding to the nozzle intervals of one nozzle row.

According to this configuration, for example, it is possible to appropriately perform printing at resolution higher than the nozzle intervals. Also, as a result, for example, it is possible to more appropriately perform higher-quality printing.

(Tenth Configuration)

A print head which performs main scan operations of ejecting ink drops while moving in a predetermined main scan direction in a printing apparatus for performing printing in an inkjet mode includes three or more nozzle rows in which a plurality of nozzles configured to eject ink drops is arranged in lines and a plurality of nozzles aligned in the main scan direction is arranged side by side in a sub scan direction perpendicular to the main scan direction, wherein the three or more nozzle rows are installed side by side in the main scan direction, and each of the nozzle rows is installed such that the positions of its ends in the sub scan direction are deviated from those of each adjacent nozzle row in the main scan direction. According to this configuration, for example, it is possible to achieve the same effects as those of the first configuration.

(Eleventh Configuration)

In a printing method of performing printing in an inkjet mode, a head unit including nozzle rows in which a plurality of nozzles configured to eject ink drops is aligned is used, and the head unit performs main scan operations of ejecting ink drops while moving in a predetermined main scan direction, the head unit includes three or more nozzle rows in which the plurality of nozzles aligned in the main scan direction is arranged side by side in a sub scan direction perpendicular to the main scan direction, and the three or more nozzle rows are installed side by side in the main scan direction, and each of the nozzle rows is installed such that the positions of its ends in the sub scan direction are deviated from those of each adjacent nozzle row in the main scan direction. According to this configuration, for example, it is possible to achieve the same effects as those of the first configuration.

(Twelfth Configuration)

A printing apparatus which performs printing in an inkjet mode includes a head unit configured to include nozzle rows in which a plurality of nozzles configured to eject ink drops is aligned, and a main scan driver configured to drive the head unit to perform main scan operations of ejecting ink drops while moving in a predetermined main scan direction, wherein the head unit includes two or more nozzle rows in which the plurality of nozzles aligned in the main scan direction is arranged side by side in a sub scan direction perpendicular to the main scan direction, and the two or more nozzle rows are installed side by side in the main scan direction, and each of the nozzle rows is installed such that the positions of its ends in the sub scan direction are deviated from those of each adjacent nozzle row in the main scan direction, and with respect to adjacent nozzle rows in the main scan direction, the magnitudes of deviations of the positions of the ends in the sub scan direction are larger than a distance which is obtained from a spatial frequency corresponding to a peak value of a visual transfer function.

In this configuration, for example, with respect to the positions of the ends of adjacent nozzle rows, by setting the magnitudes of deviations so as to be sufficiently large, it is possible to more appropriately prevent the influences of the nozzles of the ends of adjacent nozzle rows from being perceived as overlapping each other. Therefore, according to this configuration, for example, even in a case where the number of nozzle rows is 2, it is possible to achieve the same effects as those of the first configuration.

(Thirteenth Configuration)

A print head which performs main scan operations of ejecting ink drops while moving in a predetermined main scan direction in a printing apparatus for performing printing in an inkjet mode includes two or more nozzle rows in which a plurality of nozzles configured to eject ink drops is arranged in lines and a plurality of nozzles aligned in the main scan direction is arranged side by side in a sub scan direction perpendicular to the main scan direction, wherein the two or more nozzle rows are installed side by side in the main scan direction, and each of the nozzle rows is installed such that the positions of its ends in the sub scan direction are deviated from those of each adjacent nozzle row in the main scan direction, and with respect to adjacent nozzle rows in the main scan direction, the magnitudes of deviations of the positions of the ends in the sub scan direction are larger than a distance which is obtained from a spatial frequency corresponding to a peak value of a visual transfer function. According to this configuration, for example, it is possible to achieve the same effects as those of the twelfth configuration.

(Fourteenth Configuration)

In a printing method of performing printing in an inkjet mode, a head unit including nozzle rows in which a plurality of nozzles configured to eject ink drops is aligned is used, and the head unit performs main scan operations of ejecting ink drops while moving in a predetermined main scan direction, and the head unit includes two or more nozzle rows in which the plurality of nozzles aligned in the main scan direction is arranged side by side in a sub scan direction perpendicular to the main scan direction, and the two or more nozzle rows are installed side by side in the main scan direction, and each of the nozzle rows is installed such that the positions of its ends in the sub scan direction are deviated from those of each adjacent nozzle row in the main scan direction, and with respect to adjacent nozzle rows in the main scan direction, the magnitudes of deviations of the positions of the ends in the sub scan direction are larger than a distance which is obtained from a spatial frequency corresponding to a peak value of a visual transfer function. According to this configuration, for example, it is possible to achieve the same effects as those of the twelfth configuration.

### ADVANTAGEOUS EFFECTS OF INVENTION

According to the disclosure, for example, even in a case where deviations occur in the landing positions of ink drops which are ejected from the nozzles of the ends of the nozzle rows, it is possible to appropriately suppress a decrease in the quality of printing.

### BRIEF DESCRIPTION OF DRAWINGS

FIG. 1 is a view illustrating an example of a printing apparatus 10 according to an embodiment of the disclosure. FIG. 1(a) and FIG. 1(b) are a front view and a top view illustrating an example of the configuration of a main portion of the printing apparatus 10.

FIG. 2 is a view for explaining an inkjet head 150 which is used in the embodiment. FIG. 2(a) shows an example of the configuration of the inkjet head 150. FIG. 2(b) is a graph illustrating a visual transfer function.

FIG. 3 is a view illustrating an example of the state of the inkjet head 150 during main scan operations.

FIG. 4 is a view illustrating an example of the state of the inkjet head 150 during main scan operations in a case of using three nozzle rows 202-1 to 202-4.

FIG. 5 is a view illustrating an example of an arrangement of nozzles of nozzle rows 202-1 to 202-4.

FIG. 6 is a view illustrating another example of the arrangement of the nozzles of the nozzle rows 202-1 to 202-4.

FIG. 7 is a view illustrating an example of an arrangement of ink dots which are formed on a medium in a case of using the inkjet head 150 having four nozzle rows 202-1 to 202-4. FIG. 7(a) shows an example of the configuration of the inkjet head 150. FIG. 7(b) shows an example of an arrangement of ink dots which are formed on a medium.

FIG. 8 is a view illustrating an example of an arrangement of ink dots which are formed on a medium in a case of using the inkjet head 150 having three nozzle rows 202-1 to 202-3. FIG. 8(a) shows an example of the configuration of the inkjet head 150. FIG. 8(b) shows an example of an arrangement of ink dots which are formed on a medium.

FIG. 9 is a view illustrating the configurations of modifications of a head unit 12. FIG. 9(a) shows an example of the configuration of a modification of the head unit 12. FIG. 9(b) shows an example of the configuration of another modification of the head unit 12.

### DESCRIPTION OF EMBODIMENTS

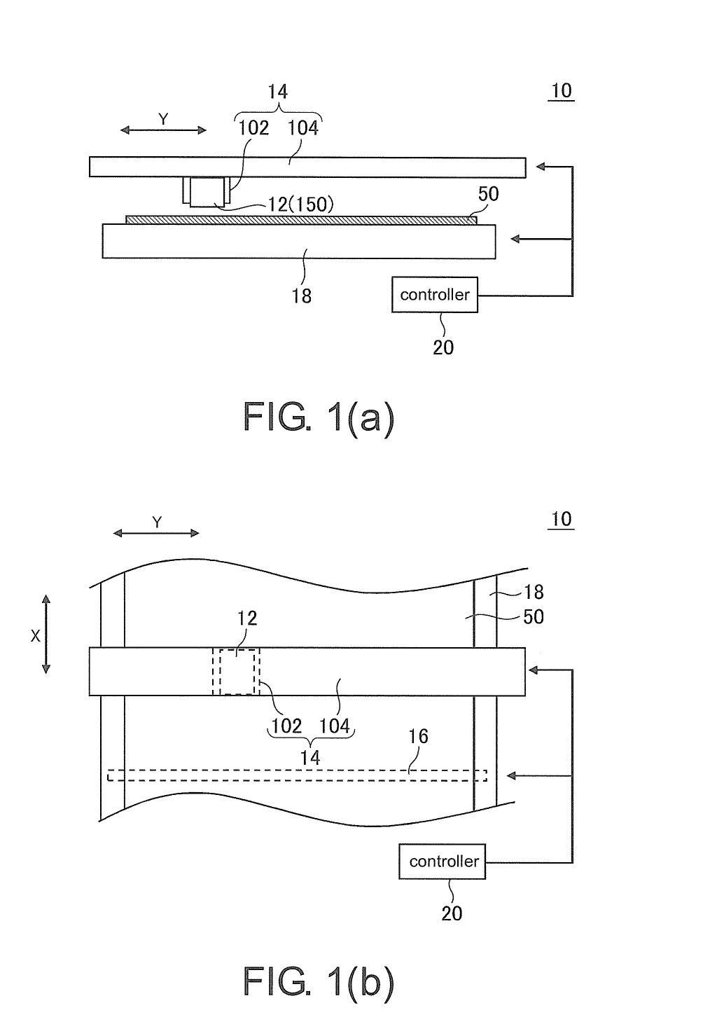

Hereinafter, embodiments according to the disclosure will be described with reference to the drawings. FIG. 1 shows an example of a printing device 10 according to an embodiment of the disclosure. FIG. 1(a) and FIG. 1(b) are a front view and a top view illustrating an example of the configuration of a main portion of the printing device 10. In the present embodiment, the printing apparatus 10 is an inkjet printer for performing printing in an inkjet mode, and includes a head unit 12, a main scan driver 14, a sub scan driver 16, a platen 18, and a controller 20.

The head unit 12 is a part having nozzle rows in which a plurality of nozzles for ejecting ink drops is lined up, and ejects ink drops onto a medium 50 which is a print target, thereby performing printing on the medium 50. In the present embodiment, the head unit 12 is configured by an inkjet head 150 having nozzle rows formed therein.

Also, the head unit 12 may be configured by, for example, a plurality of inkjet heads 150. For example, in a case of performing color printing by the printing apparatus 10, the head unit 12 has a plurality of inkjet heads 150 for ejecting ink drops of different colors (for example, ink drops of the individual colors of C, M, Y, and K), respectively. Also, the head unit may have a plurality of inkjet heads 150 with respect to the same color. The configurations of the head unit 12 and the inkjet head 150 will be described below in more detail.

The main scan driver 14 is a component for driving the head unit 12 to perform main scan operations of ejecting ink drops while moving in a predetermined main scan direction (a Y direction in the drawings). In the present embodiment, the main scan driver 14 includes a carriage 102 and a guide rail 104. The carriage 102 holds the head unit 12 such that the nozzle rows and the medium 50 face each other. The guide rail 104 is a rail for guiding movement of the carriage 102 in the main scan direction, and moves the carriage 102 in the main scan direction in response to an instruction of the controller 20.

The sub scan driver 16 is a component for making the head unit 12 perform sub scan operations of relatively moving with respect to the medium 50 in a sub scan direction (an X direction in the drawings) perpendicular to the main scan direction. In the present embodiment, the sub scan driver 16 is a roller for conveying the medium 50, and conveys the medium 50 in the intervals between main scan operations, thereby making the head unit 12 perform a sub scan operation.

Further, for example, it can also be considered to use a configuration for performing sub scan operations by moving the head unit 12 with respect to a medium 50 fixed in place (for example, an X-Y table type apparatus) without conveying the medium 50, as the configuration of the printing apparatus 10. In this case, as the sub scan driver 16, for example, a driver or the like for moving the head unit 12 by moving the guide rail 104 in the sub scan direction can be used.

The platen 18 is a board-like member for mounting the medium 50, and supports the medium 50 such that the medium faces the head unit 12. The controller 20 is, for example, a CPU of the printing apparatus 10, and controls the operation of each unit of the printing apparatus 10, for example, in response to instructions of a host PC. According to the above described configuration, the printing apparatus 10 performs printing on each medium 50.

Also, the printing device 10 may include a configuration identical or similar to that of a known inkjet printer, except for points described above or to be described below. For example, the printing apparatus 10 may further have a component for fixing ink to the medium 50, depending on the type of ink which is used. More specifically, in a case of using ink which hardens by irradiation with ultraviolet light, such as ultraviolet curing ink or solvent UV ink, the printing apparatus 10 may further include an ultraviolet light source (such as an UV LED). Also, in a case of using ink which requires evaporating solvent (such as solvent ink, latex ink, solvent UV ink, or water-based ink), the printing apparatus 10 may further have a heater for heating the medium 50, and so on.

Now, the configurations of the head unit 12 and the inkjet head 150 will be described in more detail. As described above, in a case of performing color printing by the printing apparatus 10, the head unit 12 has a plurality of inkjet heads 150 for ejecting ink drops of different colors, respectively. In this case, with respect to the arrangement of the inkjet heads 150 of the individual colors, for example, it can be considered to align the inkjet heads in line in the sub scan direction (the X direction) and install the inkjet heads side by side in the main scan direction (the Y direction). Also, in this case, in each main scan operation, the inkjet heads 150 for the individual colors eject ink drops onto the same areas of the medium 50.

Also, the inkjet heads 150 of the individual colors may be installed, for example, so as to be deviated from each other in the sub scan direction. More specifically, for example, the inkjet heads 150 of the individual colors may be installed side by side in the sub scan direction such that their positions in the sub scan direction do not overlap each other. In this case, in each main scan operation, the inkjet heads 150 for the individual colors eject ink drops onto different areas of the medium 50, respectively. Also, onto the same area of the medium 50, the inkjet heads eject ink drops of the individual colors in different main scan operations which are performed alternately with sub scan operations. In this way, the inkjet heads 150 of the individual colors perform printing in a color-sequential mode in which the inkjet heads of the individual colors sequentially perform printing on each area of the medium 50. Also, the inkjet heads 150 of the individual colors may be installed in a configuration other than the above described configurations.

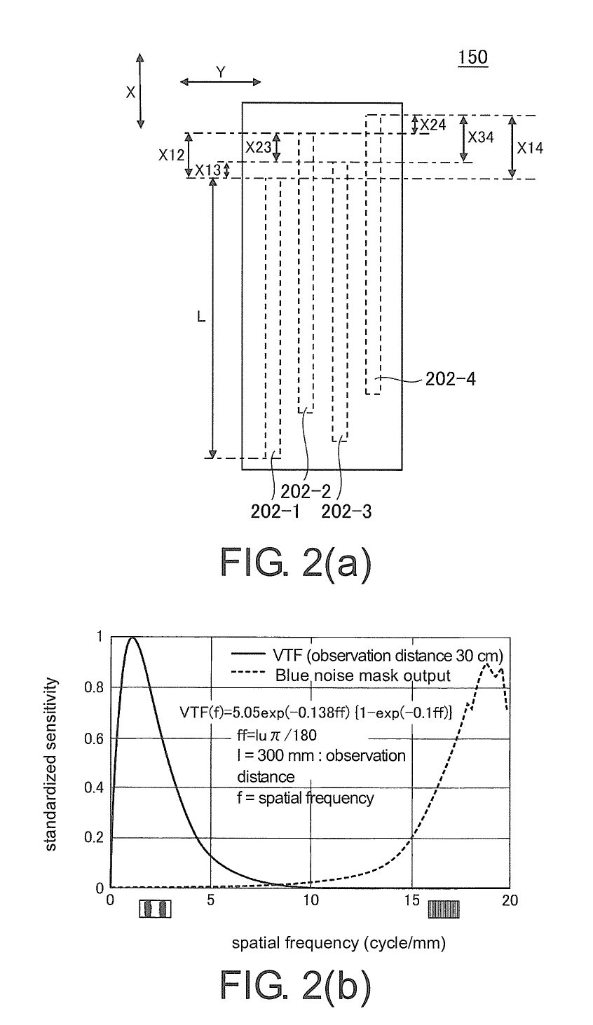

Now, the configuration of the inkjet head 150 of each color will be described in more detail. FIG. 2 is a view for explaining an inkjet head 150 which is used in the present embodiment. FIG. 2(a) shows an example of the configuration of the inkjet head 150.

The inkjet head 150 shown in FIG. 2(a) is an inkjet head for one color, and has a plurality of nozzle rows 202-1 to 202-4 for ejecting ink drops of the same color. Also, in the present embodiment, in each of the plurality of nozzle rows 202-1 to 202-4, a nozzle row direction in which nozzles are aligned in line is the sub scan direction (X direction). Therefore, in each of the plurality of individual nozzle rows 202-1 to 202-4, a plurality of nozzles which is aligned in line in the main scan direction (Y direction) is arranged side by side in the sub scan direction.

Also, the individual nozzle rows 202-1 to 202-4 are the same as one another in the number of nozzles which are arranged side by side in the sub scan direction. Therefore, the lengths of the individual nozzle rows 202-1 to 202-4 in the sub scan direction become the same length L which is determined according to the number of nozzles. Also, in the present embodiment, the nozzle rows 202-1 to 202-4 are installed side by side in the main scan direction such that the nozzles of the ends of the individual nozzle rows are deviated from each other in the sub scan direction. In this way, the nozzle rows 202-1 to 202-4 are installed side by side in the main scan direction such that the ends of adjacent nozzle rows in the main scan direction are deviated from each other in the sub scan direction.

Also, for example, as shown in FIG. 2(a), the deviation pattern of the positions of the ends of the nozzle rows 202-1 to 202-4 is a zigzag shape in which the positions of the individual nozzle rows in the sub scan direction are deviated from each other alternately back and forth. The deviation pattern may be, more specifically, for example, deviations of a jagged shape, a sinusoidal shape, or a triangular wave shape. Also, in the present embodiment, for example, in a case where three consecutive nozzle rows arranged side by side in the main scan direction are selected from the nozzle rows 202-1 to 202-4, when the selected three nozzle rows are referred to as a first row, a second row, and a third row, in the order along the main scan direction, the deviation pattern is a deviation pattern in which, with respect to the positions of the individual nozzle rows in the sub scan direction, the end position deviation between the first row and the second row is larger than the position deviation between the first row and the third row. Also, this relation is not limited to, for example, in a case of selecting first to third rows along a direction from the left to the right in FIG. 2(a), and is satisfied even in a case of selecting first to third rows along a direction from the right to the left. Also, more specifically, this relation is a relation in which, for example, with respect to the magnitudes (absolute values) of deviation amounts in the positions of the nozzle rows in the sub scan direction, in a case where the magnitudes of the deviation amounts between the individual nozzle rows 202-1 to 202-4 are denoted by X12, X13, X23, X24, X34, and X14, as shown in FIG. 2(a), X12>X13, X23>X24, X34>X24, X23>X13, and the like are satisfied.

Also, during main scan operations, each of the plurality of nozzle rows 202-1 to 202-4 repeatedly ejects ink drops in a predetermined cycle. Further, in the second and subsequent cycles, the nozzle row 202-1 positioned in one end in the main scan direction ejects ink drops onto an area adjacent to an area on the medium onto which the nozzle row 202-4 positioned on the other end has ejected ink drops. Therefore, in view of these cycles, in terms of the operation of the inkjet head 150, the nozzle row 202-1 and the nozzle row 202-4 can be considered as being substantially adjacent to each other. Therefore, it is preferable to set the deviation amount magnitude X14 in view of that point, such that some relations such as X14>X34 and X14>X12 are satisfied.

According to the above described configuration, in the printing apparatus 10 (see FIG. 1) of the present embodiment, for example, in each main scan operation during a printing operation, onto areas of the medium 50 where the head unit passes, ink drops are ejected from the nozzles of the plurality of nozzle rows 202-1 to 202-4. Therefore, according to the present embodiment, first, for example, it is possible to appropriately uniformize the ejection characteristics of the plurality of nozzle rows.

Also, during a printing operation, the printing apparatus 10 performs printing, for example, using all nozzles of the plurality of individual nozzle rows 202-1 to 202-4. Performing printing using all nozzles means using all nozzles if necessary according to a print image, without setting dummy nozzles which do not eject ink drops. According to this configuration, for example, with respect to the sub scan direction width of an area on which printing is performed by one main scan operation, it is possible to set a wider width, without reducing the width like in a case of setting dummy nozzles. Also, as a result, for example, it is possible to appropriately prevent banding and the like from occurring while preventing a decrease in printing speed. Also, as a result, it is possible to appropriately perform high-quality printing.

Also, in this configuration, the positions of the individual ends of the nozzle rows 202-1 to 202-4 are deviated from each other in the sub scan direction. Therefore, for example, the position of a nozzle of an end of each of the nozzle rows 202-1 to 202-4 in the sub scan direction is close not to a nozzle of an end of an adjacent nozzle row, but to a nozzle other than the nozzle of the end. Also, the landing positions of ink drops which are ejected by the nozzles of the ends of the individual nozzle rows 202-1 to 202-4 are deviated from each other in the sub scan direction. Therefore, for example, with respect to ink dots which are formed side by side in the main scan direction during a printing operation, for example, a dot adjacent to a dot which is formed by the nozzle of the end of each of the nozzle rows 202-1 to 202-4 is formed by a nozzle other than the nozzle of the end of another nozzle row. Therefore, during a printing operation, ink dots which are formed by the nozzles of the ends of the individual nozzle rows 202-1 to 202-4 are not aligned in the main scan direction.

Therefore, in the present embodiment, the landing positions of ink drops corresponding to the nozzles of the ends of the nozzle rows 202-1 to 202-4 can be appropriately dispersed in the sub scan direction. Also, as a result, for example, even in a case where deviations occur in the landing positions of ink drops which are ejected from the nozzles of the ends, it is possible to appropriately uniformize the influences of the deviations. Therefore, according to the present embodiment, for example, even in a case where deviations occur in the landing positions of ink drops which are ejected from the nozzles of the ends of the individual nozzle rows 202-1 to 202-4, it is possible to appropriately suppress a decrease in the quality of printing.

Also, as described above, in the present embodiment, with respect to the first row, the second row, and the third row which are three consecutive nozzle rows arranged side by side in the main scan direction, the end position deviation in the sub scan direction between the first row and the second row is larger than the end position deviation between the first row and the third row. According to this configuration, for example, it is possible to appropriately set the positions of the nozzles of the ends of the individual nozzle rows such that they are deviated from each other. Also, as compared to some cases such as a case where the ends of the individual nozzle rows are arranged so as to be deviated from each other and be put on a straight line, it is possible to appropriately disperse the landing positions of ink drops corresponding to the nozzles of the ends of the nozzle rows such that it is more difficult to visually discriminate the landing positions. Therefore, according to the present embodiment, for example, it is possible to more appropriately uniformize the influences of the deviations. Also, as a result, for example, even in a case where deviations occur in the landing positions of ink drops which are ejected from the nozzles of the ends of the nozzle rows, it is possible to more appropriately suppress a decrease in the quality of printing.

Also, in the present embodiment, the magnitudes of the deviations between adjacent nozzle rows are set, for example, in view of a visual transfer function. A visual transfer function is a function representing the sensitivity of visual recognition of human beings to spatial frequency. FIG. 2(b) shows a graph representing a visual transfer function (VTF) shown on page 173 of a book “DIGITAL PRINT TECHNOLOGY INKJET” (supervised by Mashahiko Fujii) published by the Imaging Society of Japan.

As can be seen from the graph, the waveform of the visual transfer function has a sensitivity peak (the maximum value of the sensitivity of human being's eyes to spatial frequency) at a certain spatial frequency. In associated with the visual transfer function having the above described waveform, in the present embodiment, with respect to adjacent nozzle rows in the main scan direction, the magnitudes of the deviations between the positions of the ends in the sub scan direction are set to be larger than a distance which is obtained from the spatial frequency corresponding to the peak value of the visual transfer function. In this case, the distance which is obtained from the spatial frequency corresponding to the peak value of the visual transfer function is a wavelength corresponding to the spatial frequency at which the sensitivity of the visual transfer function is peak.

According to this configuration, for example, by arranging the nozzles of the ends of adjacent nozzle rows such that their positions are sufficiently deviated from each other, it is possible to appropriately prevent the influences of the nozzles of the ends of adjacent nozzle rows from being perceived as overlapping each other. Also, as a result, for example, it is possible to more appropriately suppress a decrease in the quality of printing.

Also, as described above, in the present embodiment, in each main scan operation, ink drops are ejected from the plurality of nozzle rows 202-1 to 202-4 arranged side by side in the main scan direction. Therefore, according to the present embodiment, for example, by performing one main scan operation, it is possible to eject ink drops like in a case of performing four main scan operations with only one nozzle row. Also, as a result, for example, by one main scan operation, it is possible to perform printing like in a case of performing as many main scan operations as the number of nozzle rows in a multi-pass mode.

Also, like this, in the present embodiment, by one main scan operation, it is possible to perform printing like in a case of performing as many main scan operations as the number of nozzle rows in a multi-pass mode. Also, even in the present embodiment, printing may be performed in a multi-pass mode. For example, it can be considered to perform two-pass or four-pass printing using the four nozzle rows 202-1 to 202-4. According to this configuration, for example, it is possible to eject ink drops like in a case of performing eight or sixteen main scan operations with only one nozzle row. Also, as a result, for example, it is possible to appropriately perform higher-quality printing.

Also, in case of the present embodiment, with respect to ink dots constituting individual pixels of a print image, it is possible to form a plurality of dots arranged side by side in the main scan direction, with the plurality of nozzle rows 202-1 to 202-4 taking charge of parts thereof. Further, in this case, as compared to a case of using only one nozzle row, with respect to ink dots to be formed by one nozzle, it is possible to set large intervals in the main scan direction. Therefore, according to the present embodiment, for example, even if the movement speed of the inkjet head 150 during main scan operations increases, it is possible to appropriately form ink dots by the individual nozzles of the nozzle rows 202-1 to 202-4. Also, as a result, for example, it becomes possible to perform higher-speed printing.

Now, the relation between the configuration of the nozzle rows 202-1 to 202-4 of the present embodiment and the spatial frequency corresponding to the peak value of the visual transfer function will be described in more detail. Until now, the arrangement of the nozzle rows 202-1 to 202-4 of the inkjet head 150 has been mainly described. However, from a printed material, an observer perceives the result of printing performed by the nozzle rows 202-1 to 202-4, not the nozzle rows 202-1 to 202-4. For this reason, a result of printing performed by the nozzle rows 202-1 to 202-4 will be described with reference to some drawings.

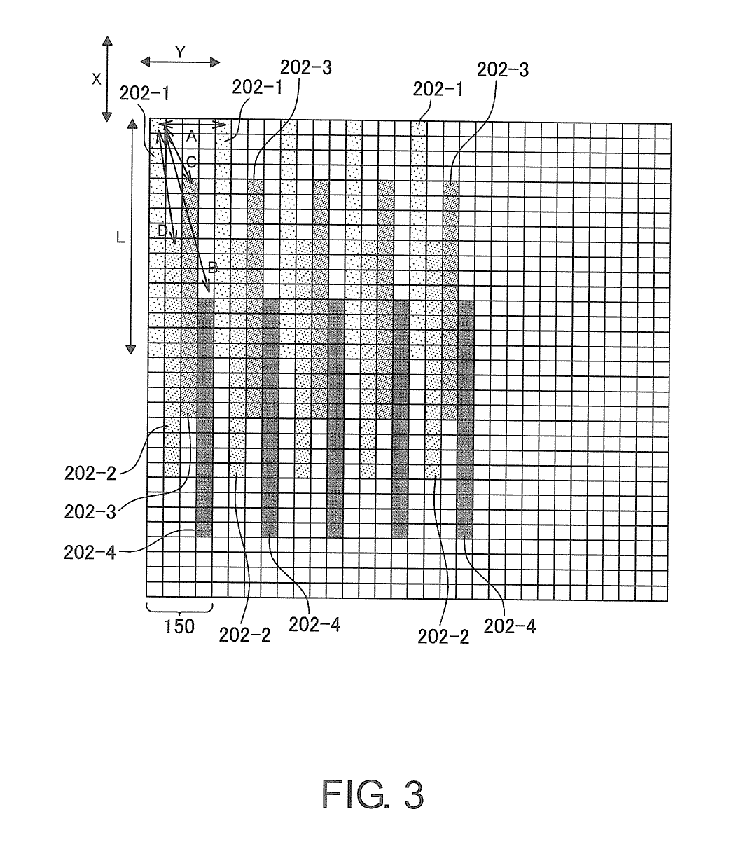

FIG. 3 is a view illustrating an example of the state of the inkjet head 150 during main scan operations, and equivalently shows the state of the inkjet head 150 which sequentially moves in the main scan direction while ejecting ink drops by illustrating the states of the individual main scan operations side by side in the main scan direction like a plurality of inkjet heads 150. In FIG. 3, the plurality of individual inkjet heads 150 represents the positions of the inkjet head 150 at different timings of the main scan operations, respectively, and represents the positions of the inkjet head 150 at timings corresponding to individual cycles in which ink drops are ejected at predetermined intervals. Also, as each of the plurality of inkjet heads 150, more specifically, the plurality of nozzle rows 202-1 to 202-4 of the inkjet head 150 is shown.

Also, in the case shown in FIG. 3, the inkjet head 150 sequentially moves to the right of FIG. 3 at constant speed. Therefore, the direction to the right of FIG. 3 can be considered as a time axis. In other words, FIG. 3 is a view illustrating the positions of the nozzles which eject ink drops, in time series, and does not show the special disposition of actual inkjet heads 150. Also, for convenience of illustration, the specific arrangement of the nozzle rows 202-1 to 202-4 is partially different from the specific configuration shown in FIG. 2. Also, the individual nozzle rows 202-1 to 202-4 have been illustrated so as to be different in the halftone dot meshing pattern and the like, such that it is easy to distinguish the nozzle rows.

As described with reference to FIG. 2 and the like, in the inkjet head 150 of the present embodiment, the nozzle rows 202-1 to 202-4 are arranged such that the ends of adjacent nozzle rows in the main scan direction are deviated from each other in the sub scan direction. Also, in main scan operations, the individual nozzle rows 202-1 to 202-4 eject ink drops at the positions of the nozzle rows 202-1 to 202-4 shown side by side in FIG. 3 in the individual cycles in which the individual nozzle rows 202-1 to 202-4 eject ink drops while moving in the main scan direction. In this way, the individual nozzle rows 202-1 to 202-4 eject ink drops onto areas whose ends in the sub scan direction are deviated from each other and which have a predetermined length L, respectively. Also, as can be seen from FIG. 3, in each of the second and subsequent ejection cycle, the nozzle row 202-1 of one end of the main scan direction ejects ink drops onto an area adjacent to an area onto which the nozzle row 202-4 of the other end of the main scan direction has ejected ink drops.

Further, in this case, according to the positions of the individual nozzle rows 202-1 to 202-4, positions where the nozzles of the ends of the nozzle rows eject ink drops in each cycle are deviated from each other. Therefore, for example, the distances between the positions where ink drops are ejected by the nozzles of the ends of the nozzle rows 202-1 to 202-4 become, for example, distances shown by “B”, “C”, and “D” in FIG. 3. Also, with respect to two consecutive and individual cycles, the nozzle of the end of one nozzle row (for example, the nozzle row 202-1) ejects ink drops, at an interval of a distance shown by “A” in FIG. 3, in the main scan direction.

Here, in a case of representing the deviation pattern of the positions of the ends of the nozzle rows 202-1 to 202-4 of the present embodiment by the state of FIG. 3 equivalently showing the states of main scan operations during printing, it can be said that the average value of the distances between the ends of adjacent nozzle rows during printing is smaller than the average value of the distances between the ends of nozzle rows having one nozzle row interposed therebetween. According to this configuration, for example, even in a case where deviations occur in the landing positions of ink drops which are ejected from the nozzles of the ends of the nozzle rows, it is possible to appropriately uniformize the influences of the deviations. Also, as a result, it is possible to appropriately suppress a decrease in the quality of printing.

Also, with respect to the deviation pattern of the positions of the ends of the nozzle rows 202-1 to 202-4, more specifically, for example, with respect to the distances shown by “B” to “D” in FIG. 3, it is preferable to set those distances larger than the distance which is obtained from the spatial frequency corresponding to the peak value of the visual transfer function. According to this configuration, for example, it is possible to appropriately prevent the influences of the nozzles of the ends of the plurality of nozzle rows from being perceived as overlapping each other. Also, as a result, for example, it is possible to more appropriately suppress a decrease in the quality of printing.

Here, the distances “B” to “D” shown in FIG. 3 correspond to the distances between ink dots which are actually formed on a medium. However, for example, in designing the inkjet head 150, it is more preferable to define necessary conditions by the positions of the nozzle rows 202-1 to 202-4, not by the distances between dots to be formed. Therefore, in this case, for example, with respect to the sub scan direction positions of the nozzles of the ends of the plurality of nozzle rows 202-1 to 202-4 of the inkjet head 150, it can be considered to set the magnitudes of deviations so as to be larger than the distance which is obtained from the spatial frequency corresponding to the peak value of the visual transfer function. According to this configuration, for example, it is possible to appropriately arrange the positions of the nozzles of the ends of the plurality of nozzle rows 202-1 to 202-4 such that the positions are sufficiently deviated from each other. Also, more specifically, for example, in the plurality of nozzle rows 202-1 to 202-4, with respect to the magnitudes of deviations between the position of the end of each nozzle row in the sub scan direction and the position of the end of each of the other nozzle rows in the sub scan direction, it is preferable to set every magnitude so as to be larger than the distance which is obtained from the spatial frequency corresponding to the peak value of the visual transfer function.

Also, in terms of practicality, it can be considered to set the magnitudes of deviations between the positions of the ends of the nozzle rows in the sub scan direction, for example, to distances equal to or larger than 200 μm. According to this configuration, it is conceivable that it is possible to appropriately arrange the positions of the nozzles of the ends of the plurality of individual nozzle rows such that they are sufficiently deviated from each other.

Also, as described above, during main scan operations, each of the nozzle rows 202-1 to 202-4 repeatedly ejects ink drops at predetermined intervals. Therefore, ink dots which are formed by the nozzle of the end of each of the nozzle rows 202-1 to 202-4 are arranged side by side in the main scan direction, at regular intervals as shown by the distance “A” in FIG. 3. Further, in this case, it is preferable to set those intervals such that they are larger than the distance which is obtained from the spatial frequency corresponding to the peak value of the visual transfer function. In other words, it is preferable to set the intervals between ink dots which are formed on a medium by each of the nozzle rows 202-1 to 202-4 during main scan operations, such that they are larger than the distance which is obtained from the spatial frequency corresponding to the peak value of the visual transfer function.

According to this configuration, for example, by setting sufficiently large intervals between dots to be faulted on a medium by one nozzle row, it is possible to appropriately prevent the states of dots which are formed side by side in the main scan direction by the nozzle of the end, from being perceived as overlapping each other. Also, as a result, for example, it is possible to more appropriately suppress a decrease in the quality of printing.

Here, with reference to FIG. 2 and FIG. 3, with respect to the case of using the four nozzle rows 202-1 to 202-4, the relation between the configuration of the nozzle rows 202-1 to 202-4 and the spatial frequency corresponding to the peak value of the visual transfer function has been described. However, the above described relation is identical or similar to those in cases different in the number of nozzle rows. Now, this point will be described in more detail.

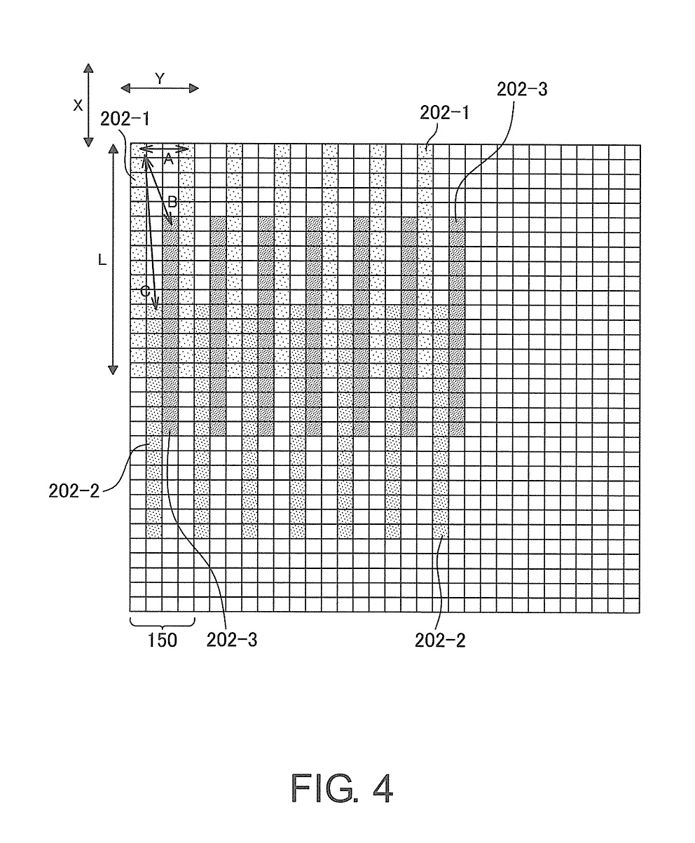

FIG. 4 shows an example of the state of the inkjet head 150 during main scan operations in a case of using three nozzle rows 202-1 to 202-3. In this case, the inkjet head 150 during main scan operations performs operations identical or similar to those in the case described with reference to FIG. 3, except for the difference in the number of nozzle rows. Therefore, even in this case, similarly in the case described with reference to FIG. 2, for example, it is preferable to set distances shown by “A” to “C” in FIG. 4 such that those distances are larger than the distance which is obtained from the spatial frequency corresponding to the peak value of the visual transfer function. Also, in terms of practicality, those distances may be set, for example, to 200 μm or greater. According to this configuration, it is possible to appropriately prevent the influences of the nozzles of the ends of the individual nozzle rows from being perceived as overlapping each other. Also, as a result, for example, it is possible to more appropriately suppress a decrease in the quality of printing.

Also, for example, more nozzle rows may be used, and, for example, the number of nozzle rows may be 5 or greater. Further, for example, as long as the positions of the individual nozzle rows are sufficiently deviated from each other as described above, for example, a case where the number of nozzle rows of the inkjet head 150 is 2 is conceivable. Even in this case, by appropriately preventing the influences of the nozzles of the ends of the individual nozzle rows from being perceived as overlapping each other, for example, it is possible to more appropriately suppress a decrease in the quality of printing.

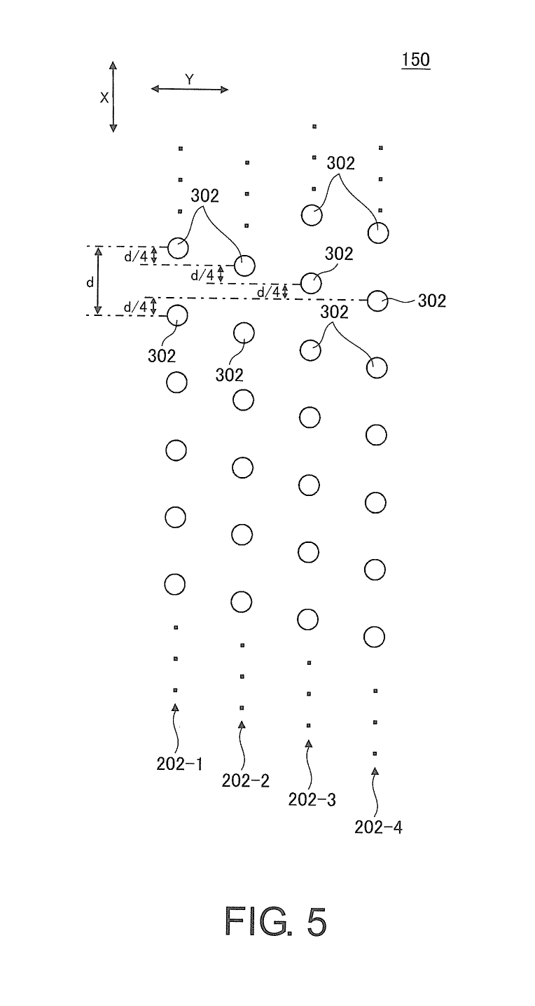

Now, the arrangement of the nozzles of the nozzle rows 202-1 to 202-4 will be described in more detail. FIG. 5 is a view illustrating an example of the arrangement of the nozzles of the nozzle rows 202-1 to 202-4, and shows an example of the arrangement of the nozzles of the inkjet head 150 described with reference to FIGS. 1 to 4.

In the present embodiment, each of the nozzle rows 202-1 to 202-4 is composed of a plurality of nozzles 302 which is aligned at predetermined nozzle intervals in the sub scan direction. Also, in each of the nozzle rows 202-1 to 202-4, the positions of the individual nozzles 302 in the sub scan direction are deviated from the positions of all nozzles 302 of the other nozzle rows. Also, according to this configuration, with respect to resolution in the sub scan direction, the printing apparatus 10 (see FIG. 1) performs printing at resolution higher than resolution corresponding to the nozzle intervals of one nozzle row.

For example, as shown in FIG. 5, in each of the nozzle rows 202-1 to 202-4, the plurality of nozzles 302 is aligned at predetermined intervals “d” in the sub scan direction. Also, the positions of the nozzles 302 of each of the nozzle rows 202-1 to 202-4 in the sub scan direction are deviated from the nozzles 302 of each adjacent nozzle row in the sub scan direction by d/4. More specifically, in the present embodiment, in the positions of the nozzles 302 of two adjacent nozzle rows, the positions of the nozzles 302 corresponding to one nozzle row positioned on the right in FIG. 5 are deviated toward the lower side of FIG. 5 from the nozzles 302 of the other nozzle row positioned on the left in FIG. 5 by d/4. In this case, corresponding nozzles mean nozzles closest to each other in the sub scan direction. Therefore, when all nozzles 302 of the plurality of nozzle rows 202-1 to 202-4 are collectively seen, the intervals between the nozzles 302 in the sub scan direction are d/4. Also, as a result, with respect to resolution in the sub scan direction, the printing apparatus 10 performs printing at resolution corresponding to the nozzle intervals “d/4”. In this way, in the present embodiment, printing is performed at resolution higher than the nozzle intervals “d” of one nozzle row. Therefore, according to the present embodiment, for example, it is possible to more appropriately perform higher-quality printing.

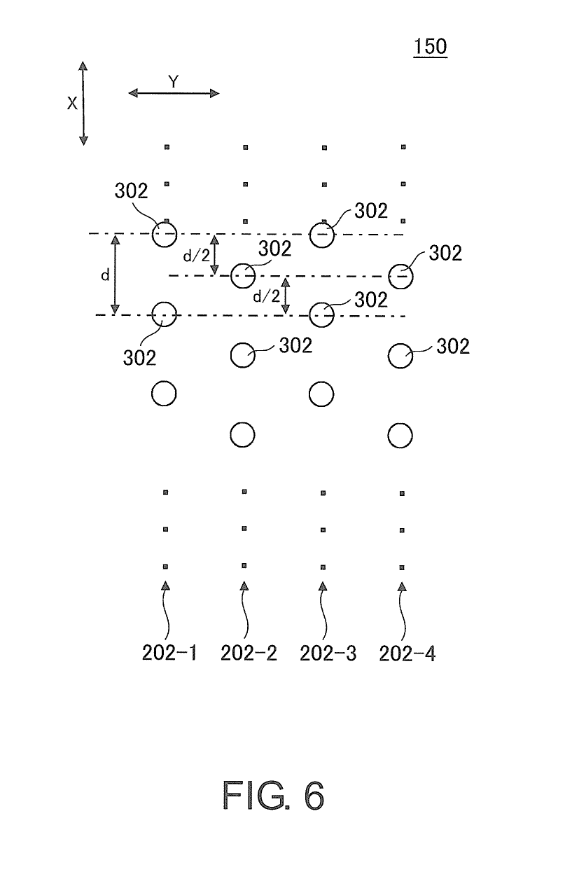

Also, the positional relation of the nozzles 302 between the nozzle rows 202-1 to 202-4 can be set to a relation other than the above described positional relation. FIG. 6 shows another example of the arrangement of the nozzles of the nozzle rows 202-1 to 202-4. Also, in FIG. 6, components denoted by the same reference symbols as those of FIG. 5 have features identical or similar to those of the components of FIG. 5, except for points to be described below.

Even in each of the nozzle rows 202-1 to 202-4 shown in FIG. 6, similarly in the configuration shown in FIG. 5, the plurality of nozzles 302 is aligned at the predetermined intervals “d” in the sub scan direction. Meanwhile, the deviation pattern of the positions of the nozzles between two adjacent nozzle rows is different from that in the configuration shown in FIG. 5. More specifically, in the configuration shown in FIG. 6, the magnitude of a deviation of the positions of corresponding nozzles 302 between two adjacent nozzle rows is d/2. Also, with respect to two nozzle rows having one nozzle row interposed therebetween, the positions of corresponding nozzles 302 are aligned in the sub scan direction. Therefore, when all nozzles 302 of the plurality of nozzle rows 202-1 to 202-4 are collectively seen, the intervals between the nozzles 302 in the sub scan direction are d/2. Also, as a result, with respect to resolution in the sub scan direction, the printing apparatus 10 performs printing at resolution corresponding to the nozzle intervals “d/2”.

Even in this configuration, for example, it is possible to appropriately perform printing at resolution higher than the nozzle intervals of one nozzle row. Also, as a result, for example, it is possible to more appropriately perform high-quality printing.

Also, the positional relation of the nozzles 302 between the nozzle rows 202-1 to 202-4 can be set to a relation other than those in the configurations shown in FIGS. 5 and 6 and so on. For example, with respect to all of the plurality of nozzle rows 202-1 to 202-4, it can also be considered to align the positions of corresponding nozzles 302 in the sub scan direction. Even in this configuration, for example, as described in association with FIG. 2 and so on, it is possible to appropriately perform high-quality printing.

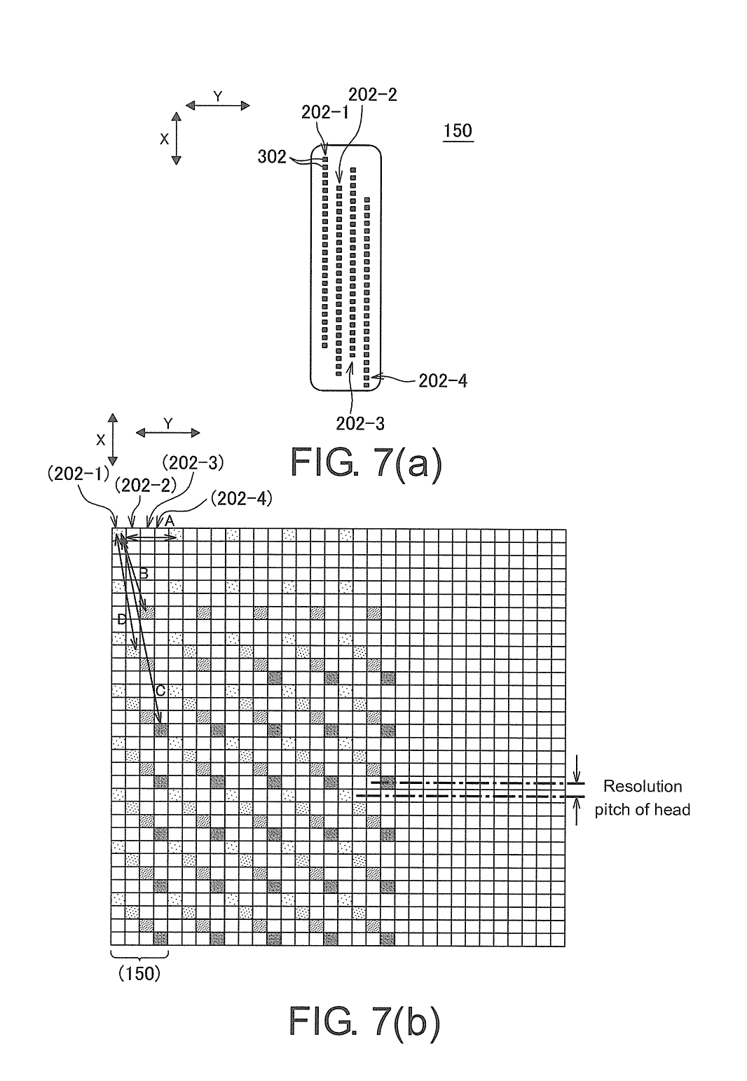

Now, in association with the arrangement of the nozzles described with reference to FIG. 5 and so on, an arrangement of ink dots which are formed on a medium will be described in more detail. With respect to the case of using the inkjet head 150 having the four nozzle rows 202-1 to 202-4, FIG. 7 shows an example of an arrangement of ink dots which are formed on a medium. Also, in FIG. 7, components denoted by the same reference symbols as those of FIGS. 1 to 6 have features identical or similar to those of the components of FIGS. 1 to 6, except for points to be described below.

FIG. 7(a) shows an example of the configuration of the inkjet head 150. In this configuration, similarly in the configuration described with reference to FIG. 2, FIG. 5, and so on, the inkjet head 150 has the plurality of nozzle rows 202-1 to 202-4 arranged such that the positions of their ends in the sub scan direction are deviated from each other. Also, in the plurality of nozzle rows 202-1 to 202-4, the plurality of nozzles 302 is aligned in the sub scan direction. Also, similarly in the configuration described with reference to FIG. 5, in each of the nozzle rows 202-1 to 202-4, the positions of the individual nozzles 302 in the sub scan direction are deviated from the positions of all nozzles 302 of the other nozzle rows in the sub scan direction. More specifically, in this configuration, for example, in a case of setting the intervals of the arrangement of the nozzles of each of the nozzle rows 202-1 to 202-4 to “d”, the positions of the nozzles 302 of each of the nozzle rows 202-1 to 202-4 in the sub scan direction are deviated from the nozzles 302 of each adjacent nozzle row in the sub scan direction by d/4.

FIG. 7(b) is a view illustrating an example of an arrangement of ink dots which are formed on a medium, and shows the state of the inkjet head 150 during main scan operations, and examples of the positions of ink dots which are formed on a medium by the individual nozzle rows 202-1 to 202-4. In this case, the state of the inkjet head 150 during main scan operations is a state equivalently representing the inkjet head 150 during the main scan operations, for example, similarly to FIG. 3 and so on. Also, in FIG. 7(b), in cells corresponding to individual pixels of an image to be depicted on a medium, the positions of ink dots to be formed on the medium by the individual nozzle rows 202-1 to 202-4 are filled with different halftone dot meshing patterns.

Also, even in this configuration, distances shown by “A” to “D” in FIG. 7(b) are set to be larger than the distance which is obtained from the spatial frequency corresponding to the peak value of the visual transfer function. These distances may be, for example, distances equal to or larger than 200 μm. According to this configuration, it is possible to appropriately prevent the states of dots which are formed by the nozzles of the ends of the nozzle rows 202-1 to 202-4 from being perceived as overlapping each other. Also, as a result, for example, it is possible to more appropriately suppress a decrease in the quality of printing.

Also, in this case, as apparent from FIG. 7, the resolution pitch of the whole of the inkjet head 150 in the sub scan direction becomes ¼ of the interval between two nozzles of each nozzle row. Therefore, according to this configuration, for example, similarly in the case described with reference to FIG. 5 and so on, it is possible to appropriately perform printing at resolution higher than the nozzle intervals of one nozzle row. Also, as a result, for example, it is possible to more appropriately perform high-quality printing.

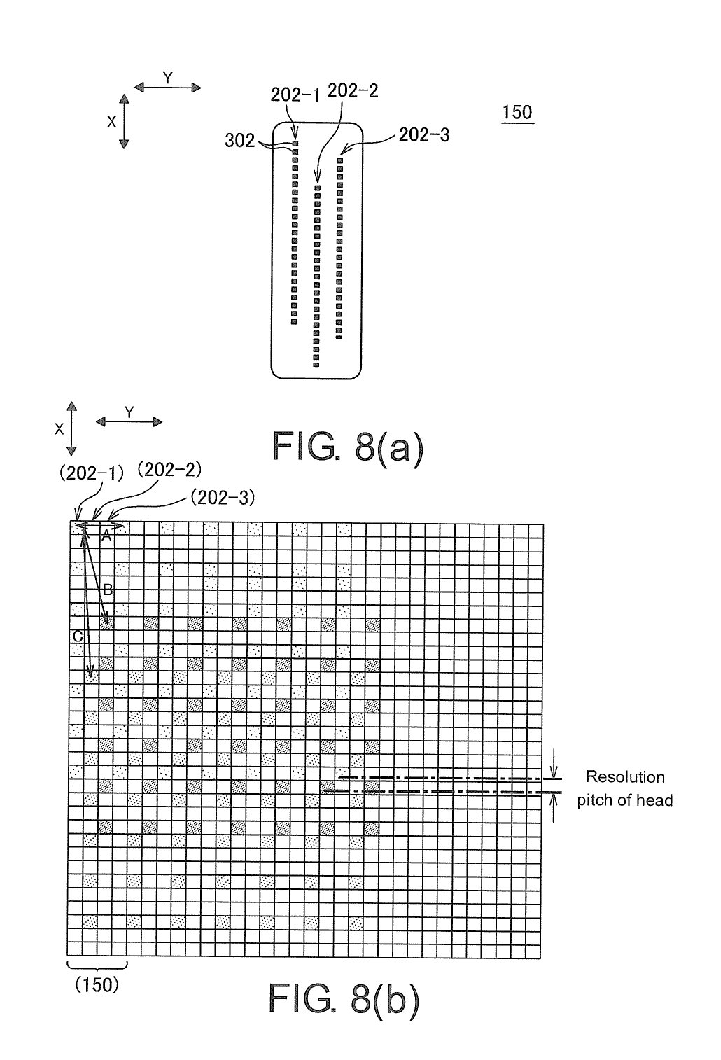

Also, this high-resolution printing is possible even in a case where the number of nozzle rows is not 4. With respect to the case of using the inkjet head 150 having three nozzle rows 202-1 to 202-3, FIG. 8 shows an example of an arrangement of ink dots which are formed on a medium. Also, in FIG. 8, components denoted by the same reference symbols as those of FIGS. 1 to 7 have features identical or similar to those of the components of FIGS. 1 to 7, except for points to be described below.

FIG. 8(a) shows an example of the configuration of the inkjet head 150. FIG. 8(b) is a view illustrating an example of an arrangement of ink dots which are formed on a medium, and shows the state of the inkjet head 150 during main scan operations, and examples of the positions of ink dots which are formed on a medium by the individual nozzle rows 202-1 to 202-3.

Even in this configuration, distances shown by “A” to “C” in FIG. 8(b) are set to be larger than the distance which is obtained from the spatial frequency corresponding to the peak value of the visual transfer function. These distances may be, for example, distances equal to or larger than 200 pm. According to this configuration, it is possible to appropriately prevent the states of dots which are formed by the nozzles of the ends of the individual nozzle rows 202-1 to 202-3 from being perceived as overlapping each other. Also, as a result, for example, it is possible to more appropriately suppress a decrease in the quality of printing.

Also, in this case, as apparent from FIG. 8, the resolution pitch of the whole of the inkjet head 150 in the sub scan direction becomes 1/3 of the interval between two nozzles of each nozzle row. Therefore, according to this configuration, for example, similarly in the case described with reference to FIG. 5, FIG. 7, and so on, it is possible to appropriately perform printing at resolution higher than the nozzle intervals of one nozzle row. Also, as a result, for example, it is possible to more appropriately perform high-quality printing.

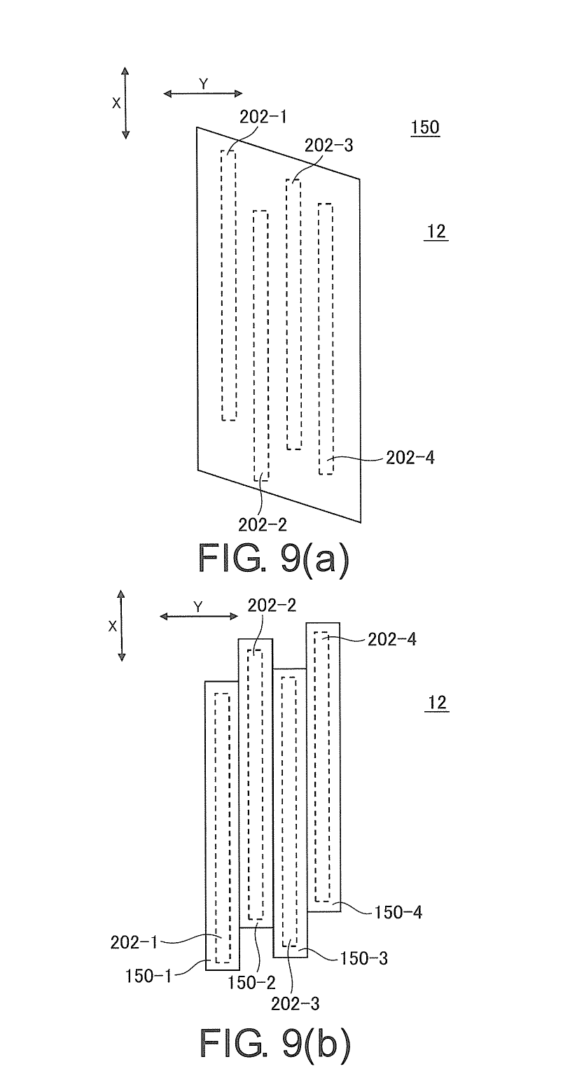

Now, with respect to the configuration of the head unit 12 (see FIG. 1), modifications will be described. FIG. 9 shows the configurations of the modifications of the head unit 12. Also, in FIG. 9, components denoted by the same reference symbols as those of FIGS. 1 to 8 have features identical or similar to those of the components of FIGS. 1 to 8, except for points to be described below.

FIG. 9(a) shows an example of the configuration of a modification of the head unit 12. In the present modification, in the head unit 12, the inkjet head 150 for each color has a plurality of nozzle rows 202-1 to 202-4, similarly in the configuration described with reference to FIG. 2 and so on. Also, the positions of the plurality of individual nozzle rows 202-1 to 202-4 are deviated from each other in a zigzag shape in the sub scan direction.

Also, in the present modification, the shape of the nozzle surface of the inkjet head 150 having the nozzle rows 202-1 to 202-4 formed therein is a parallelogram shape in which one side and the other side in the sub scan direction are inclined with respect to the main scan direction, according to the deviation pattern of the positions of the nozzle rows 202-1 to 202-4. The shape of the nozzle surface may be, for example, a rhombic shape.

According to this configuration, for example, it is possible to more efficiently dispose the plurality of nozzle rows 202-1 to 202-4 such that their positions in the sub scan direction are deviated from each other. Also, even in this case, similarly to the configurations described with reference to FIGS. 1 to 6, for example, even in a case where deviations occur in the landing positions of ink drops which are ejected from the nozzles of the ends of the nozzle rows, it is possible to appropriately suppress a decrease in the quality of printing. Also, as a result, for example, it is possible to appropriately perform high-quality printing.

Now, another modification of the head unit 12 will be described. Until now, the configuration in the case of using one inkjet head 150 having a plurality of nozzle rows 202-1 to 202-4 formed therein, as an inkjet head for one color (for example, any one of the individual colors C, M, Y, and K) in the head unit 12 has been mainly described. However, in the head unit 12, for one color, a plurality of inkjet heads 150 may be used.

FIG. 9(b) is a view illustrating an example of the configuration of another modification of the head unit 12, and shows an example of a configuration in a case of using a plurality of inkjet heads 150 for one color. As shown in FIG. 9(b), in the head unit 12 of the present modification, a combined head which is composed of a plurality of inkjet heads 150-1 to 150-4 arranged side by side in the main scan direction is used as an inkjet head for one color. The plurality of inkjet heads 150-1 to 150-4 is inkjet heads having the same configuration, and is installed side by side in the main scan direction such that their positions in the sub scan direction are deviated from each other in a zigzag shape. Also, each of the plurality of inkjet heads 150-1 to 150-4 has a plurality of nozzle rows 202-1 to 202-4 which is the same in the number of nozzles aligned.

Even in this configuration, in the head unit 12, the plurality of nozzle rows 202-1 to 202-4 for the same color is arranged similarly in the case shown in FIG. 2 and so on. Therefore, even in the present modification, for example, even in a case where deviations occur in the landing positions of ink drops which are ejected from the nozzles of the ends of the nozzle rows, it is possible to appropriately suppress a decrease in the quality of printing. Also, as a result, for example, it is possible to appropriately perform high-quality printing.

Also, even in the case of using a plurality of inkjet heads as inkjet heads for one color, the number of nozzle rows which each inkjet head has may be two or more. Even in this configuration, similarly in each configuration described above, for example, it is possible to appropriately perform high-quality printing.

Also, until now, with respect to the configuration of the head unit 12, portions onto which ink drops of one color are ejected has been mainly described. However, in the printing apparatus 10 (see FIG. 1), printing may be performed with ink of a plurality of colors. In this case, for example, with respect to inkjet heads and nozzle rows for ejecting ink drops of the individual colors, it is possible to use configurations identical or similar to the configurations described with reference to FIGS. 2 to 7.

Also, in this case, the deviation pattern of the positions of the ends of the plurality of nozzle rows for the same color may depend on each color. More specifically, for example, with respect to each ink color C, M, Y, and K, it can be considered to set the deviation pattern of the positions of the ends of the plurality of nozzle rows for the corresponding color so as to be different from the deviation pattern of the positions of the ends of the plurality of nozzle rows of each of the other colors. According to this configuration, for example, even in a case where deviations occur in the landing positions of ink drops which are ejected from the nozzles of the ends of the nozzle rows, it is possible to more appropriately suppress a decrease in the quality of printing. Also, for example, if necessary, with respect to only some colors, it is possible to use configurations identical or similar to the configurations described with reference to FIGS. 2 to 7.

Although the disclosure has been described above by way of the embodiment, the technical scope of the disclosure is not limited to the scope described in the embodiment. It is apparent to those skilled in the art that it is possible to make various changes or modifications in the above described embodiment. It is apparent from a description of claims that forms obtained by making such changes or modifications can also be included in the technical scope of the disclosure.

### INDUSTRIAL APPLICABILITY

The disclosure can be suitably used, for example, in printing devices.

### DESCRIPTION OF REFERENCE SIGN

10: printing apparatus
12: head unit
14: main scan driver
16: sub scan driver
18: platen
20: controller
50: medium
102: carriage
104: guide rail
150: inkjet head
202: nozzle row
302: nozzle

1-14. (canceled)

15. A printing apparatus which performs printing in an inkjet mode, comprising:
a head unit configured to include nozzle rows in which a plurality of nozzles configured to eject ink drops is aligned; and
a main scan driver configured to drive the head unit to perform main scan operations of ejecting ink drops while moving in a predetermined main scan direction,
wherein the head unit includes two or more nozzle rows in which the plurality of nozzles aligned in the main scan direction is arranged side by side in a sub scan direction perpendicular to the main scan direction, and
the two or more nozzle rows are installed side by side in the main scan direction, and each of the nozzle rows is installed such that the positions of its ends in the sub scan direction are deviated from those of each adjacent nozzle row in the main scan direction, and
with respect to adjacent nozzle rows in the main scan direction.

16. The printing apparatus according to claim 15, wherein
the head unit includes three or more nozzle rows in which the plurality of nozzles having positions aligned in the main scan direction is arranged side by side in a sub scan direction perpendicular to the main scan direction, and
the three or more nozzle rows are installed side by side in the main scan direction, and each of the nozzle rows is installed such that the positions of its ends in the sub scan direction are deviated from those of each adjacent nozzle row in the main scan direction.

17. The printing apparatus according to claim 16, wherein
even in a case where three consecutive nozzle rows which are arranged side by side in the main scan direction are selected from the three or more nozzle rows, when the selected three nozzle rows are referred to as a first row, a second row, and a third row in the order along the main scan direction, with respect to the positions of the ends of the individual nozzle rows in the sub scan direction, the position deviation between the first row and the second row is larger than the position deviation between the first row and the third row.

18. The printing apparatus according to claim 16, wherein
the individual nozzle rows are the same in the number of nozzles which are aligned in the sub scan direction therein, and
the three or more nozzle rows are installed side by side in the main scan direction such that the positions of the ends of the individual nozzle rows are deviated from each other in the sub scan direction.

19. The printing apparatus according to claim 16, wherein
the head unit includes four or more nozzle rows which are arranged side by side in the main scan direction.

20. The printing apparatus according to claim 16, wherein
with respect to adjacent nozzle rows in the main scan direction, the magnitudes of deviations of the positions of the ends in the sub scan direction are larger than a distance which is obtained from a spatial frequency corresponding to a peak value of a visual transfer function.

21. The printing apparatus according to claim 20, wherein
in the three or more nozzle rows, all of the magnitudes of the deviations between the positions of the ends of each nozzle row in the sub scan direction, and the positions of the ends of the other nozzle rows in the sub scan direction are larger than the distance which is obtained from the spatial frequency corresponding to the peak value of the visual transfer function.

22. The printing apparatus according to claim 16, wherein
the intervals in the main scan direction between ink dots which are formed on a medium by the individual nozzle rows during the main scan operations are larger than a distance which is obtained from a spatial frequency corresponding to a peak value of a visual transfer function.

23. The printing apparatus according to claim 16, wherein
during a printing operation of performing printing on a medium, printing is performed using all nozzles of the individual nozzle rows.

24. The printing apparatus according to claim 16, wherein
in the individual nozzle rows, the plurality of nozzles is aligned in line at predetermined nozzle intervals in the sub scan direction,
in each nozzle row, the positions of each nozzle in the sub scan direction are deviated from the positions of all nozzles of the other nozzle rows in the sub scan direction, and
with respect to resolution in the sub scan direction, the printing apparatus performs printing at resolution higher than resolution corresponding to the nozzle intervals of one nozzle row.

25. The printing apparatus according to claim 15, wherein
with respect to adjacent nozzle rows in the main scan direction, the magnitudes of deviations of the positions of the ends in the sub scan direction are larger than a distance which is obtained from a spatial frequency corresponding to a peak value of a visual transfer function.

26. A print head which performs main scan operations of ejecting ink drops while moving in a predetermined main scan direction in a printing apparatus for performing printing in an inkjet mode, comprising:
two or more nozzle rows in which a plurality of nozzles configured to eject ink drops is arranged in lines and a plurality of nozzles aligned in the main scan direction is arranged side by side in a sub scan direction perpendicular to the main scan direction,
wherein the two or more nozzle rows are installed side by side in the main scan direction, and each of the nozzle rows is installed such that the positions of its ends in the sub scan direction are deviated from those of each adjacent nozzle row in the main scan direction, and
with respect to adjacent nozzle rows in the main scan direction, the magnitudes of deviations of the positions of the ends in the sub scan direction are larger than a distance which is obtained from a spatial frequency corresponding to a peak value of a visual transfer function.

27. The print head according to claim 26, wherein
three or more nozzle rows in which a plurality of nozzles configured to eject ink drops is arranged in lines and a plurality of nozzles aligned in the main scan direction is arranged side by side in a sub scan direction perpendicular to the main scan direction,
wherein the three or more nozzle rows are installed side by side in the main scan direction, and each of the nozzle rows is installed such that the positions of its ends in the sub scan direction are deviated from those of each adjacent nozzle row in the main scan direction.

28. A printing method of performing printing in an inkjet mode, wherein
a head unit including nozzle rows in which a plurality of nozzles configured to eject ink drops is aligned is used,
the head unit performs main scan operations of ejecting ink drops while moving in a predetermined main scan direction,
the head unit includes two or more nozzle rows in which the plurality of nozzles aligned in the main scan direction is arranged side by side in a sub scan direction perpendicular to the main scan direction,
the two or more nozzle rows are installed side by side in the main scan direction, and each of the nozzle rows is installed such that the positions of its ends in the sub scan direction are deviated from those of each adjacent nozzle row in the main scan direction, and
with respect to adjacent nozzle rows in the main scan direction, the magnitudes of deviations of the positions of the ends in the sub scan direction are larger than a distance which is obtained from a spatial frequency corresponding to a peak value of a visual transfer function.

29. The print method according to claim 28, wherein
the head unit includes three or more nozzle rows in which the plurality of nozzles aligned in the main scan direction is arranged side by side in a sub scan direction perpendicular to the main scan direction, and
the three or more nozzle rows are installed side by side in the main scan direction, and each of the nozzle rows is installed such that the positions of its ends in the sub scan direction are deviated from those of each adjacent nozzle row in the main scan direction.
